(19) United States
(12) Patent Application Publication
(10) Pub. No.: US 2016/0004332 A1
(43) Pub. Date: Jan. 7, 2016

(54) METHOD, DEVICE AND EQUIPMENT FOR SIMULATING MULTI-POINT TOUCH BY USING TWO ROCKERS

(71) Applicant: SUZHOU SNAIL TECHNOLOGY DIGITAL CO., LTD, Suzhou (CN)

(72) Inventors: Jian Qiu, Shenzhen (CN); Shiqiu Liu, Shenzhen (CN); Xun Tang, Shenzhen (CN); Zhi Deng, Shenzhen (CN); Shan Wang, Shenzhen (CN)

(21) Appl. No.: 14/322,748

(22) Filed: Jul. 2, 2014

(51) Int. Cl. G06F 3/0338; G06F 3/0488; G06F 3/0481; G06F 3/0484; G06F 3/02; G06F 3/041

(52) U.S. Cl. CPC G06F 3/0338; G06F 3/0227; G06F 3/0416; G06F 3/04812; G06F 3/04845; G06F 3/0488

(57) ABSTRACT

The embodiments of the present invention discloses a method for simulating multitouch with two joysticks, comprising: receiving movement parameters input during movement of the first joystick and the second joystick; obtaining movement traces of a first mouse pointer corresponding to the first joystick and a second mouse pointer corresponding to the second joystick on the graphical interface of a terminal unit, according to the movement parameters; and, generating a corresponding touch gesture signal, according to the movement traces of the first mouse pointer and the second mouse pointer. With the present invention, non-touch screen display terminals can support multitouch, and thereby the compatibility of such terminal units is improved.

### I. TECHNICAL FIELD

The present invention relates to the field of electronics, in particular to a method, a device, and an equipment for simulating multitouch with two joysticks.

### II. TECHNICAL BACKGROUND

Multitouch is a technique implemented with man-machine interaction and hardware equipment together, and can realize man-machine interaction with a computer without conventional input device. Multitouch technique is implemented with a touch screen or touchpad, and is different from single touch technique in man machine interactive operations at multiple points on the touch screen at the same time. With the development of touch technology, multitouch technique is applied more and more widely. Accordingly, software developers have developed many application programs supporting multitouch, such as game programs. However, such application program can't run on terminal units with a non-touch screen. Owing to the fact that non-touch screen terminal units will be washed out gradually, software developers are unwilling to spend time and labor to develop application programs suitable for non-touch screen terminal units. Consequently, application programs compatible to non-touch screen devices become less and less. How to support multitouch operations on non-touch screen terminal units becomes a challenge at present.

### III. CONTENTS OF THE INVENTION

The technical problem to be solved by the examples of the present invention is to provide a method, a device, and an equipment for simulating multitouch with two joysticks, which can overcome the drawback that non-touch screen display terminals don't support multitouch in the prior art.

To solve the technical problem described above, in the embodiments of the present invention, a method for simulating multitouch with two joysticks is provided, comprising:

receiving movement parameters input during movement of a first joystick and a second joystick;
obtaining movement traces of a first mouse pointer corresponding to the first joystick and a second mouse pointer corresponding to the second joystick on the graphical interface of a terminal unit, according to the movement parameters;
generating a corresponding touch gesture signal according to the movement traces of the first mouse pointer and the second mouse pointer.

Accordingly, in the embodiments of the present invention, a device for simulating multitouch with two joysticks is provided, comprising:

a receiving module, designed to receive movement parameters input during movement of a first joystick and a second joystick;
a computing module, designed to obtain movement traces of a first mouse pointer corresponding to the first joystick and a second mouse pointer corresponding to the second joystick on the graphical interface of a terminal unit, according to the movement parameters;
a generating module, designed to generate a corresponding touch gesture signal according to the movement traces of the first mouse pointer and the second mouse pointer.

Moreover, in the embodiments of the present invention, a set of electronic equipment comprising the device described above is provided.

The embodiments of the present invention can result in the following beneficial effects:

The movement parameters of the first joystick and the second joystick are detected, and are converted into movement traces of the first mouse pointer and the second mouse pointer on the graphical interface of a terminal unit, and the corresponding touch gesture signal is generated according to the movement traces of the first mouse pointer and the second mouse pointer; thus, the drawback that non-touch screen display terminals don't support multitouch in the prior art is overcome, and the compatibility of such terminal units is improved.

### IV. DESCRIPTION OF DRAWINGS

For better understanding of the technical scheme in the embodiments of the present invention or in the prior art, hereunder the accompanying drawings used in the description of the embodiments or the prior art will be introduced briefly. Apparently, the accompanying drawings described below only illustrate some embodiments of the present invention. The person skilled in the art can obtain drawings of other embodiments on the basis of these drawings without creative labor.

FIG. 1 is a schematic diagram of a structure of the device for simulating multitouch with two joysticks according to an embodiment of the present invention;

FIG. 2 is a schematic diagram of another structure of the device for simulating multitouch with two joysticks according to an embodiment of the present invention;

FIG. 3 is a schematic structural diagram of the computing module shown in FIG. 2;

FIG. 4 is a schematic structural diagram of the generating module shown in FIG. 2;

FIG. 5 is a flow chart of the method for simulating multitouch with two joysticks according to an embodiment of the present invention;

FIG. 6 is another flow chart of the method for simulating multitouch with two joysticks according to an embodiment of the present invention.

### V. EMBODIMENTS

Hereunder the technical scheme according to the embodiments of the present invention will be described clearly and completely with reference to the accompanying drawings. Apparently, the described embodiments are only parts of embodiments of the present invention, but not all embodiments of the present invention. Other embodiments obtained by the person skilled in the art without creative labor, on the basis of the embodiments provided here, shall be deemed as falling into the protection scope of the present invention.

Please see FIG. 1, which is a schematic diagram of a structure of the device for simulating multitouch with two joysticks (hereafter referred to as device 1) according to an embodiment of the present invention. The device 1 comprises:

a receiving module 11, designed to receive movement parameters input during movement of a first joystick and a second joystick;

Specifically, the first joystick and the second joystick are arranged on the casing of a terminal unit. When the user operates the first joystick and the second joystick, the first joystick and the second joystick move and cause changes of their movement parameters (e.g., amplitude and direction of movement of the joysticks); the receiving module 11 receives the movement parameters input during movement of the first joystick and the second joystick, wherein, the movement parameters input by the first joystick or second joystick are analog values, each joystick corresponds to a maximum movement amplitude, and the joystick moves within the range of the maximum movement amplitude, and the movement direction is X direction or Y direction.

a computing module 12, designed to obtain movement traces of a first mouse pointer corresponding to the first joystick and a second mouse pointer corresponding to the second joystick on the graphical interface of a terminal unit, according to the movement parameters;

Specifically, using the first joystick as an example, the computing module 12 converts the movement parameters input by the first joystick into an offset on the graphical interface of the terminal unit, wherein, the movement amplitude of the joystick is positively correlated with the offset of the mouse pointer on the graphical interface of the terminal unit, which is to say, the higher the movement amplitude of the first joystick is, the greater the offset of the first mouse pointer will be; on the contrary, the lower the movement amplitude of the first joystick is, the smaller the offset of the first mouse pointer will be; in addition, the movement direction of the joystick is the same as the movement direction of the mouse pointer on the graphical interface of the terminal unit, which is to say, when the first joystick is moved towards X direction, the first mouse pointer will move towards X direction accordingly. The computing module 12 computes and obtains the final position of the first mouse pointer according to the offset, movement direction, and initial position of the first mouse pointer, and thereby obtains the movement trace of the first mouse pointer from the initial position to the final position, wherein, the computing module 12 obtains the movement trace of the second mouse pointer on the graphical interface of the terminal unit according to the movement parameters of the second joystick in the same principle; hence, that procedure will not be described here.

a generating module 13, designed to generate a corresponding touch gesture signal according to the movement traces of the first mouse pointer and the second mouse pointer.

Specifically, the generating module 13 generates a corresponding touch gesture signal according to the relative movement direction between the first mouse pointer and the second mouse pointer. For example, if the movement traces of the first mouse pointer and the second mouse pointer indicate that the two mouse pointers move towards each other, the generating module 13 will generate a touch gesture signal for a zoom-out operation, and send the touch gesture signal to the terminal unit, so that the terminal unit can execute the corresponding operation. Appropriate touch gesture signals can be defined as required, corresponding to the movement traces of the first mouse pointer and the second mouse pointer, and there is no specific restriction on such a definition in the present invention.

In the embodiment of the present invention, the movement parameters of a first joystick and a second joystick are detected, and are converted into movement traces of a first mouse pointer and a second mouse pointer on the graphical interface of a terminal unit, and a corresponding touch gesture signal is generated according to the movement traces of the first mouse pointer and the second mouse pointer; thus, the drawback that non-touch screen display terminals don't support multitouch in the prior art is overcome, and the compatibility of such terminal units is improved.

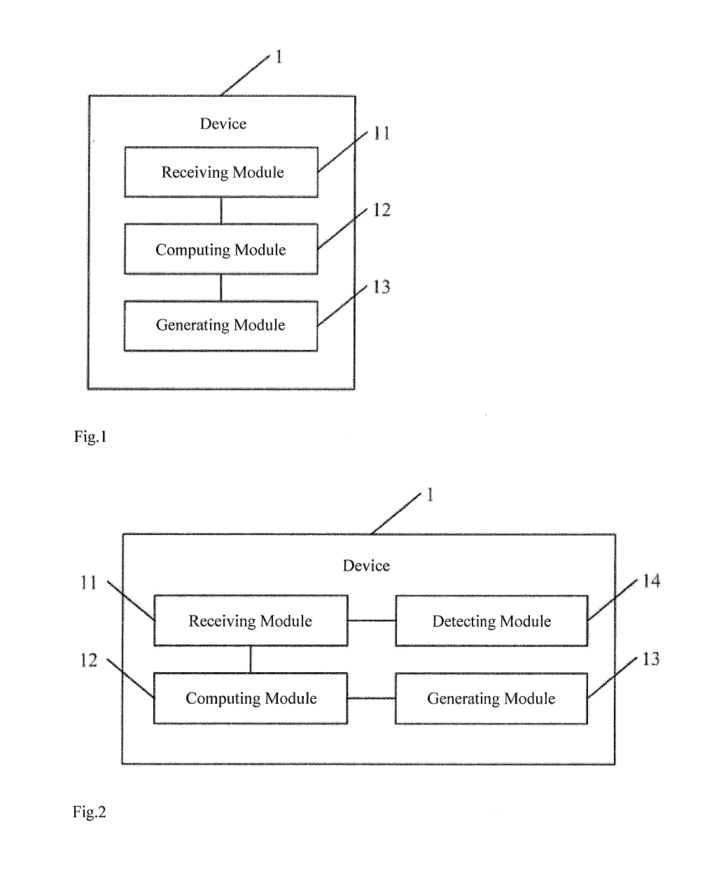

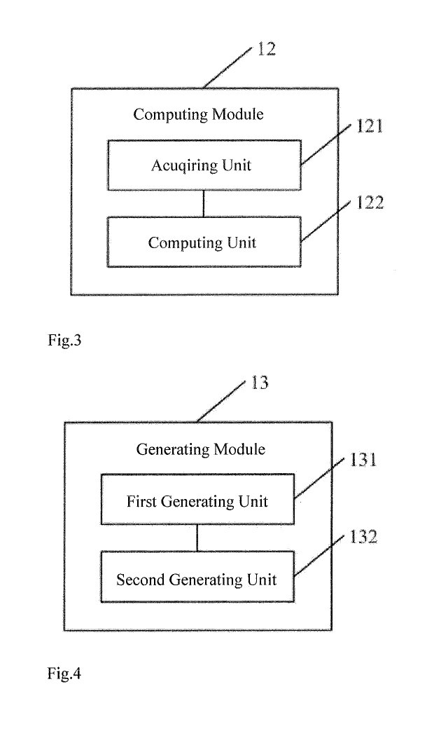

Please see FIGS. 2-4, which are schematic diagrams of another structure of the device for simulating multitouch with two joysticks (hereafter referred to as device 1) according to an embodiment of the present invention. The device 1 further comprises the receiving module 11, computing module 12, and generating module 13, and further comprises:

a detecting module 14, which detects whether the current graphical interface of the terminal unit is a specified graphical interface, if so, displays the first mouse pointer and the second mouse pointer on the specified graphical interface;

Specifically, if the specified graphical interface is the interface of a touch screen application program, when the detecting module 14 detects that the current graphical interface of the terminal unit is the interface of the specified touch screen application program, the detecting module 14 will display the first mouse pointer and the second mouse pointer on each sub-interface of the touch screen application program. Of course, the specified graphical interface can be any other graphical interface, and there is no specific restriction on it in the present invention.

Wherein, the computing module 12 comprises:

an acquiring unit 121, designed to acquire the initial positions of the first mouse pointer and the second mouse pointer on the graphical interface of the terminal unit.

Specifically, using the first mouse pointer as example, the initial position of the first mouse pointer is set when the terminal unit is initialized. Suppose the initial position of the first mouse is (x0, y0). When the first mouse pointer moves, the corresponding coordinate will be updated in real time. The updated coordinate is used as the coordinate of the initial position before the next move of the mouse pointer, and the coordinate of the initial position is saved in the memory. The acquiring unit 121 acquires the initial position of the first mouse pointer on the graphical interface of the terminal unit from the memory. Moreover, the acquiring unit 121 acquires the initial position of the second mouse pointer in the same principle.

a computing unit 122, designed to obtain the movement traces of the first mouse pointer and the second mouse pointer according to the initial positions and movement parameters;

Specifically, using the first joystick as an example, the computing unit 122 computes the movement trace of the first mouse pointer according to the movement parameters of the first joystick and the initial position of the first mouse pointer acquired by the acquiring unit 121. The movement parameters of the first joystick include movement amplitude and movement direction. In the movement parameters of the first joystick, suppose the movement amplitude is A and the movement direction is the positive half of X axis, and suppose the coordinate of the initial position of the first mouse pointer is (x0, y0), the offset of the first mouse pointer on the graphical interface will be k*A unit coordinate, according to the fact that the movement amplitude A is proportional to the offset of the mouse pointer, where, k is the proportion factor of the movement amplitude of the first joystick to the offset of the mouse pointer, and is a constant; hence, the final position of the first mouse pointer on the graphical interface will be (x0+k*A, y0). The movement trace of the first mouse pointer on the graphical interface obtained by the computing module 122 is a straight line extending from coordinates (x0, y0) to coordinates (x0+k*A, y0), wherein, the computing unit 122 obtains the movement trace of the second mouse pointer according to the movement parameters of the second joystick in the same principle; hence, that procedure will not be described here.

The generating module 13 comprises:

a first generating unit 131, designed to generate a touch gesture signal that indicates a zoom-in operation, when the first mouse pointer and the second mouse pointer are detected to move away from each other according to the movement traces; and/or
a second generating unit 132, designed to generate a touch gesture signal that indicates a zoom-out operation, when the first mouse pointer and the second mouse pointer are detected to move towards each other according to the movement traces.

In the embodiment of the present invention, the movement parameters of a first joystick and a second joystick are detected, and are converted into movement traces of a first mouse pointer and a second mouse pointer on the graphical interface of a terminal unit, and a corresponding touch gesture signal is generated according to the movement traces of the first mouse pointer and the second mouse pointer; thus, the drawback that non-touch screen display terminals don't support multitouch in the prior art is overcome, and the compatibility of such terminal units is improved.

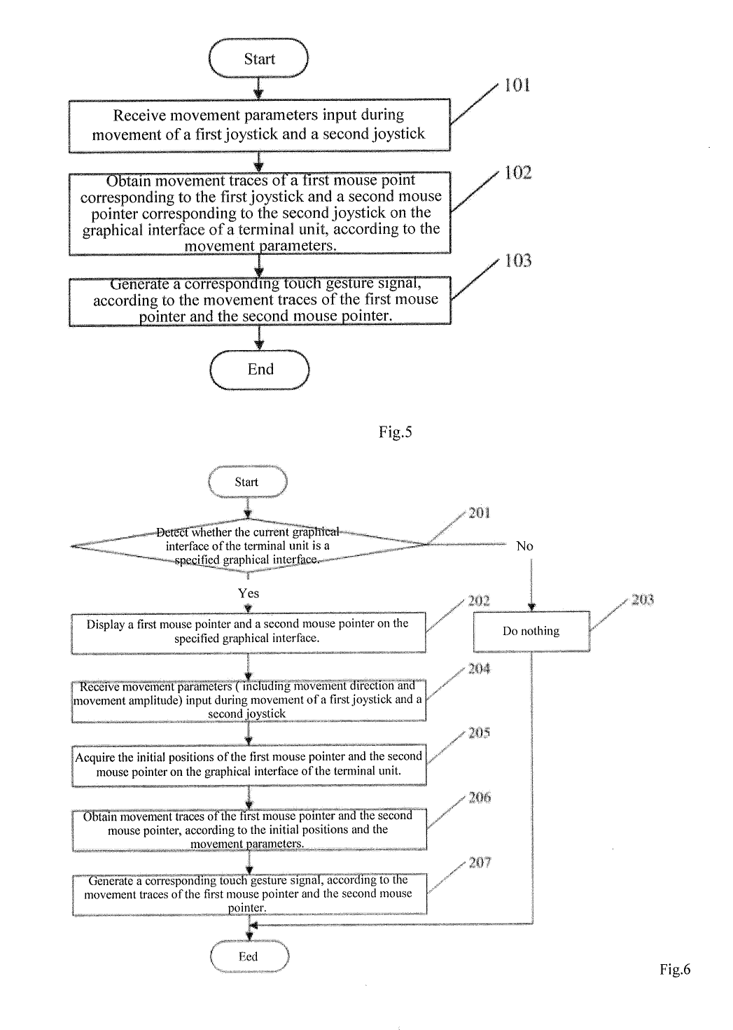

Please see FIG. 5, which is a flow chart of the method for simulating multitouch with two joysticks according to an embodiment of the present invention. The method comprises:

step 101: receiving movement parameters input during the movement of a first joystick and a second joystick;

step 102: obtaining movement traces of a first mouse pointer corresponding to the first joystick and a second mouse pointer corresponding to the second joystick on the graphical interface of a terminal unit, according to the movement parameters;

step 103: generating a corresponding touch gesture signal according to the movement traces of the first mouse pointer and the second mouse pointer.

In the embodiment of the present invention, the movement parameters of a first joystick and a second joystick are detected, and are converted into movement traces of a first mouse pointer corresponding to the first joystick and a second mouse pointer corresponding to the second joystick on the graphical interface of a terminal unit, and a corresponding touch gesture signal is generated according to the movement traces of the first mouse pointer and the second mouse pointer; thus, the drawback that non-touch screen display terminals don't support multitouch in the prior art is overcome, and the compatibility of such terminal units is improved.

Please see FIG. 6, which is another flow chart of the method for simulating multitouch with two joysticks according to an embodiment of the present invention. The method comprises:

step 201: detecting whether the current graphical interface of a terminal unit is the specified graphical interface;

Specifically, suppose the specified graphical interface is the interface of a touch screen application program, if the detecting module 14 detects that the current graphical interface of the terminal unit is the specified interface of the touch screen application program, step 202 will be executed; otherwise step 203 will be executed. Of course, the specified graphical interface can be any other graphical interface, and there is no specific restriction on it in the present invention.

step 202: displaying a first mouse pointer and a second mouse pointer on the specified graphical interface;

step 203: doing nothing;

step 205: receiving movement parameters (including movement direction and movement amplitude) input during movement of a first joystick and a second joystick;

Specifically, the first joystick and the second joystick are arranged on the casing of a terminal unit. When the user operates the first joystick and the second joystick, the first joystick and the second joystick move and cause changes of their movement parameters (e.g., movement amplitude and movement direction of the joysticks); the receiving module 11 receives the movement parameters input during movement of the first joystick and the second joystick, wherein, the movement parameters input by the first joystick or second joystick are analog values, each joystick corresponds to a maximum movement amplitude, and the joystick moves within the range of the maximum movement amplitude, and the movement direction is X direction or Y direction.

step 206: acquiring the initial positions of the first mouse pointer and the second mouse pointer on the graphical interface of the terminal unit;

step 207: obtaining the movement traces of the first mouse pointer and the second mouse pointer, according to the initial positions and movement parameters;

step 208: generating a corresponding touch gesture signal according to the movement traces of the first mouse pointer and the second mouse pointer.

In the embodiment of the present invention, the movement parameters of a first joystick and a second joystick are detected, and are converted into movement traces of a first mouse pointer corresponding to the first joystick and a second mouse pointer corresponding to the second joystick on the graphical interface of a terminal unit, and a corresponding touch gesture signal is generated according to the movement traces of the first mouse pointer and the second mouse pointer; thus, the drawback that non-touch screen display terminals don't support multitouch in the prior art is overcome, and the compatibility of such terminal units is improved.

The person skilled in the art can understand that the process flows of the methods according to the above embodiments can be implemented in part or entirely by utilizing a computer program to instruct relevant hardware, the computer program can be stored in a computer readable storage medium, and the program can comprise the process flows of the embodiments of the methods described above when it is executed, wherein, the storage medium can be a magnetic disk, optical disk, Read-Only Memory (ROM), or Random Access Memory (RAM), etc.

While the present invention is described and disclosed above in some preferred embodiments, the present invention is not limited to those embodiments. The person skilled in the art can appreciate that any equivalent modification or variation that can implement the process flows in the embodiments described above in part or entirely on the basis of the claims of the present invention is deemed as falling into the protection scope of the present invention.

1-11. (canceled)

12. A method for simulating multitouch with two joysticks, comprising:
receiving movement parameters input during movement of a first joystick and a second joystick;
obtaining movement traces of a first mouse pointer corresponding to the first joystick and a second mouse pointer corresponding to the second joystick on the graphical interface of a terminal unit, according to the movement parameters;
generating a corresponding touch gesture signal according to the movement traces of the first mouse pointer and the second mouse pointer.

13. The method according to claim 12, wherein, the movement parameters include movement direction and movement amplitude, and the step of receiving the movement parameters input during movement of the first joystick and the second joystick comprises:
receiving the movement parameters, which include movement direction and movement amplitude, and are input during movement of the first joystick and the second joystick.

14. The method according to claim 13, further comprising the following step before the step of receiving the movement parameters input during movement of the first joystick and the second joystick:
detecting whether the current graphical interface of the terminal unit is a specified graphical interface, and, if so, displaying the first mouse pointer and the second mouse pointer on the specified graphical interface.

15. The method according to claim 14, wherein, the step of obtaining movement traces of a first mouse pointer corresponding to the first joystick and a second mouse pointer corresponding to the second joystick on the graphical interface of a terminal unit according to the movement parameters comprises:
acquiring the initial positions of the first mouse pointer and the second mouse pointer on the graphical interface of the terminal unit;
obtaining the movement traces of the first mouse pointer and the second mouse pointer, according to the initial positions and movement parameters.

16. The method according to claim 12, wherein, the step of generating a corresponding touch gesture signal according to the movement traces of the first mouse pointer and the second mouse pointer comprises:
generating a touch gesture signal that indicates a zoom-in operation, when the first mouse pointer and the second mouse pointer are detected to move away from each other according to the movement traces; and/or
generating a touch gesture signal that indicates a zoom-out operation, when the first mouse pointer and the second mouse pointer are detected to move towards each other according to the movement traces.

17. A device for simulating multitouch with two joysticks, comprising:
a receiving module, designed to receive movement parameters input during movement of a first joystick and a second joystick are moved;
a computing module, designed to obtain movement traces of a first mouse pointer corresponding to the first joystick and a second mouse pointer corresponding to the second joystick on the graphical interface of a terminal unit, according to the movement parameters;
a generating module, designed to generate a corresponding touch gesture signal according to the movement traces of the first mouse pointer and the second mouse pointer.

18. The device according to claim 17, wherein, the receiving module is designed to:
receive the movement parameters, which includes movement direction and movement amplitude, and are input during movement of the first joystick and the second joystick.

19. The device according to claim 18, further comprising:
a detecting module, which detects whether the current graphical interface of the terminal unit is a specified graphical interface, and, if so, displays the first mouse pointer and the second mouse pointer on the specified graphical interface.

20. The device according to claim 19, wherein, the computing module comprises:
an acquiring unit, designed to acquire the initial positions of the first mouse pointer and the second mouse pointer on the graphical interface of the terminal unit;
a computing unit, designed to obtain the movement traces of the first mouse pointer and the second mouse pointer, according to the initial positions and movement parameters.

21. The device according to claim 20, wherein, the generating module comprises:
a first generating unit, designed to generate a touch gesture signal that indicates a zoom-in operation, when the first mouse pointer and the second mouse pointer are detected to move away from each other according to the movement traces; and/or
a second generating unit, designed to generate a touch gesture signal that indicates a zoom-out operation, when the first mouse pointer and the second mouse pointer are detected to move towards each other according to the movement traces.

22. A set of electronic equipment, comprising the device according to claim 17.

23. The method according to claim 13, wherein, the step of generating a corresponding touch gesture signal according to the movement traces of the first mouse pointer and the second mouse pointer comprises:
generating a touch gesture signal that indicates a zoom-in operation, when the first mouse pointer and the second mouse pointer are detected to move away from each other according to the movement traces; and/or
generating a touch gesture signal that indicates a zoom-out operation, when the first mouse pointer and the second mouse pointer are detected to move towards each other according to the movement traces.

24. The method according to claim 14, wherein, the step of generating a corresponding touch gesture signal according to the movement traces of the first mouse pointer and the second mouse pointer comprises:
generating a touch gesture signal that indicates a zoom-in operation, when the first mouse pointer and the second mouse pointer are detected to move away from each other according to the movement traces; and/or
generating a touch gesture signal that indicates a zoom-out operation, when the first mouse pointer and the second mouse pointer are detected to move towards each other according to the movement traces.

25. The method according to claim 15, wherein, the step of generating a corresponding touch gesture signal according to the movement traces of the first mouse pointer and the second mouse pointer comprises:
generating a touch gesture signal that indicates a zoom-in operation, when the first mouse pointer and the second mouse pointer are detected to move away from each other according to the movement traces; and/or
generating a touch gesture signal that indicates a zoom-out operation, when the first mouse pointer and the second mouse pointer are detected to move towards each other according to the movement traces.

26. A set of electronic equipment, comprising the device according to claim 18.

27. A set of electronic equipment, comprising the device according to claim 19.

28. A set of electronic equipment, comprising the device according to claim 20.

29. A set of electronic equipment, comprising the device according to claim 21.
